(19) United States
(12) Patent Application Publication
(10) Pub. No.: US 2014/0201002 A1
(43) Pub. Date: Jul. 17, 2014

(54) SYSTEM AND METHOD FOR ADVERTISING

(71) Applicant: Marie-Helene Nicastro, Gatineau (CA)

(72) Inventor: Marie-Helene Nicastro, Gatineau (CA)

(21) Appl. No.: 14/105,413

(22) Filed: Dec. 13, 2013

Related U.S. Application Data
(60) Provisional application No. 61/797,816, filed on Dec. 14, 2012.

(51) Int. Cl. G06Q 30/02; H04M 3/42

(52) U.S. Cl. CPC G06Q 30/0261; H04M 3/42059
USPC 705/14.58; 705/14.4

(57) ABSTRACT

The present invention is generally directed toward a method for providing an advertisement to user equipment. The method includes providing and transmitting an advertisement message and caller ID data including sender identification information to user equipment having a display. The advertisement message and caller ID data are received by the user equipment and displayed on the display.

### REFERENCE TO PENDING APPLICATIONS

This application claims the benefit of pending U.S. Provisional Patent Application No. 61/797,816 filed on Dec. 14, 2012.

### BACKGROUND OF THE INVENTION

The present invention relates to generally to advertising and more specifically, to a method for delivering advertisements to a device equipped to display caller identification information.

Currently, telecommunication systems include a caller (calling party) ID capability Caller ID is a telephone service that transmits a caller's number to the called party's telephone equipment during the ringing signal, or when the call is being set up but before the call is answered. Where available, caller ID can also provide a name associated with the calling telephone number. The information made available to the called party may be displayed on a telephone's display, on a separately attached device, or personal computer.

Additionally, the sending of advertising messages has been used by telecommunication systems in the prior art. These prior art advertising systems are subscription based such that a called party would first be a subscriber of the advertising services. U.S. Pat. No. 6,952,469 is an example of the prior art subscription based advertising services. This prior art system requires an end user to first subscribe to an advertisement service. That service would then transmit caller ID data associated to the advertising service along with an advertisement message. In other words, the phone number, and if equipped the name, of the advertising service would be transmitted.

There is a disadvantage as the transmitting of an advertisement message must first be based upon a subscription with an advertisement service company. Thus, there is a need for an improved telecommunication system-based advertisement service.

### SUMMARY OF THE INVENTION

The present invention satisfies the needs discussed above. The present invention relates to generally to advertising and more specifically, to a system and method for delivering advertisements to a device equipped to display caller identification information.

In general, the inventive concept disclosed is directed toward a method and system for providing an advertisement message over a telecommunication network to an end user. This advertisement message is delivered along with Caller ID data to end user's equipment but where the advertisement message is independent of the party originating the phone call. Whereas the prior art disclosed the advertisement message and Caller ID data to be from the same party such as the advertising provider, the present invention does not have such limitation. The advertisement message is sent along with Caller ID data for any phone call made in the normal course, such as phone calls from friends and family.

By not being limited to subscribers, the range of potential recipients of advertisement messages is limited to only the number of devices having Caller ID display capabilities. Further, on account that the advertisement providers are not required to engage in a subscription service, the number of advertisement providers would be increased. This increase would allow for many variations of advertisements and sales promotions such as providing reduced cost user equipment and/or free items or reduced fees or free data plan, more minutes included in the calling minutes plan including pre-paid calling cards in exchange for advertising based telephone and network services. These variations can also include collaboration between telecommunication network providers and advertisement providers to provide targeted advertisement messages by location, age group, and other demographics. Additionally, while the prior art is directed to a single advertisement per phone call, the present invention is directed to a system and method that can provide one or more advertisements per phone call. Moreover, the one or more advertisements can alternate being displayed between the caller ID data and the advertisement message; the message can be received multiple times a day or week.

In one aspect of the present invention, a method for providing an advertisement over a caller identification system is disclosed. This aspect includes transmitting advertisement message and sender identification information, hereinafter referred to as Caller ID data, to a telephonic device equipped to display Caller ID data. Such devices can include, but are not limited to, hand-held mobile phones and internet-enabled phones.

The device receives the Caller ID data and the advertisement message. The advertisement message and Caller ID data are then displayed.

The displaying of the advertisement message and Caller ID data are displayed in various arrangements, including alternating displays and displaying the advertisement message before the Caller ID data is displayed.

The advertisement message can be in the form of a text message or image. This will allow the advertisement to display words along with logos and other images related to the advertisement.

Additionally, the location of the telephonic device can be determined through known methods and means, upon which time the advertisement messages can be tailored for the specific location of the telephonic device. Another aspect of the inventive method is the age of the end user can be determined through known methods and means, upon which time the advertisement messages can be specifically tailored for that age group.

In another aspect of the present invention, a system for providing an advertisement over a caller identification system is disclosed. This aspect includes a telephonic network providing telephonic services to a plurality of end users having equipment capable of receiving and displaying Caller ID data, an advertisement management component that processes advertisement messages such that the advertisement messages are sent to at least one of the plurality of end users along with the Caller ID data.

Upon reading the included description, various alternative embodiments will become obvious to those skilled in the art. These embodiments are to be considered within the scope and spirit of the subject invention, which is only, limited by the claims which follow and their equivalents.

### BRIEF DESCRIPTION OF THE DRAWINGS

FIG. 1 is a schematic of an embodiment of the method of the present invention.

FIG. 2 is a block diagram of an embodiment of the system of the present invention.

### DESCRIPTION OF THE PREFERRED EMBODIMENTS

The present invention relates to generally to advertising and more specifically, to a system and method for delivering advertisements to a device equipped to display caller identification information.

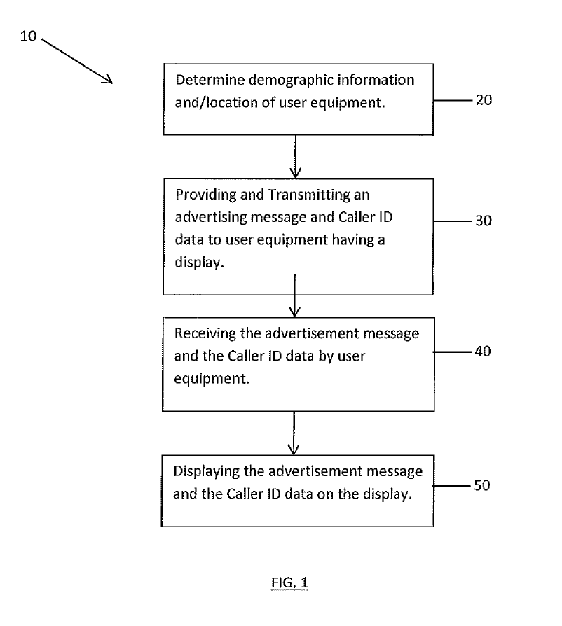

As illustrated in FIG. 1, an embodiment 10 of the inventive method is disclosed. Examining the invention in more detail, FIG. 1 shows embodiment 10 having the steps of providing and transmitting, step 30, one or more advertisement messages 134 and Caller ID data 138 of a sending party to at least one user equipment 140 having a display. The Caller ID data 138 includes sender identification information. The sender party is not associated or related to the advertisement message provider.

The user equipment 140 then, at step 40, receives the advertisement message 134 and Caller ID data 138 and then displays such advertisement message 134 and Caller ID data 138. The displaying of the advertisement message 134 and Caller ID data 138 can alternate or can be one before the other, such as the advertisement message 134 displayed before Caller ID data 138 is displayed.

The advertisement message 134 can be in the form of a text message, an image such as a logo or a combination thereof.

The user equipment can be any device that is capable of receiving and displaying Caller ID data, such as a hand-held telephone.

In the embodiment illustrated in FIG. 1, the demographic information of the receiving party, such as age, sex and/or the location of the user equipment 140 is first determined, at step 20, and then a location specific advertisement message is transmitted to that user equipment.

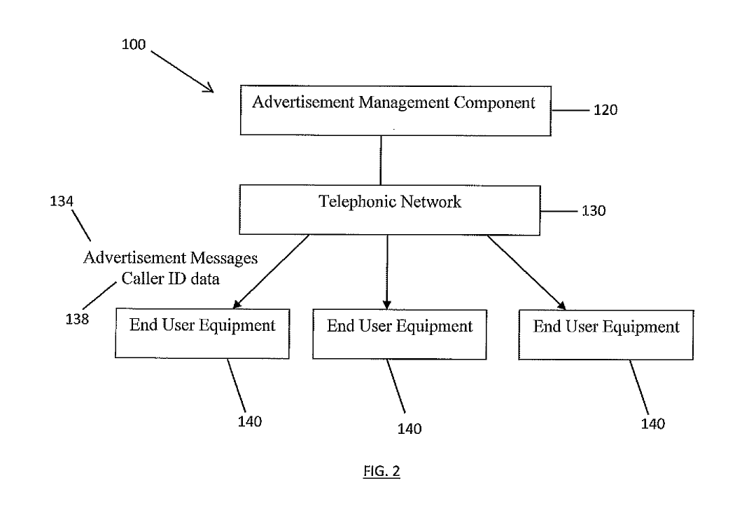

As illustrated in FIG. 2, an embodiment 100 of the inventive system is disclosed. Examining the invention in more detail, FIG. 2 shows embodiment 100 including a telephonic network 130 providing telephonic services to a plurality of end user equipment 140 capable of receiving and displaying Caller ID data 138, along with an advertisement management component 120 that processes advertisement messages 134 such that the advertisement messages 134 are sent to the end user equipment 140 along with the Caller ID data 138.

Another aspect of the present invention is directed towards the end user equipment 140 such that is has the capability to store the advertisement message 134 in a memory contained therein. This aspect will allow the advertisement message 134 to be replayed for the end user at a later time that when it was first received by the end user equipment 138.

In operation, when a telephone call is made in the ordinary course by a sending party where Caller ID data will be transmitted to the receiving party, one or more advertisement messages will also be sent to the receiving party. The telecommunications service provider that controls and sends the Caller ID data would be able to select from a pool of advertisement messages contained within a database of such messages. The selection of the specific advertisement messages can be based on various factors, such as but not limited to demographic information, location information and contractual obligations.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

We claim:

1. A method for providing an advertisement during a telephone call is made by a sending party in the ordinary course by a sending party where Caller ID data will be transmitted to the receiving party, the steps comprising:
a. providing one or more advertisement messages and caller ID data associated with the sending party's identification information;
b. transmitting the caller ID data and the one or more advertisement messages to receiving party's user equipment, said user equipment having a display;
c. receiving, the caller ID data and the one or more advertisement messages by the user equipment; and
d. displaying the sender identification information and the one or more advertisement messages on the display.

2. The method of claim 1, wherein the displaying of the sender identification information is alternately displayed with the one or more advertisement messages.

3. The method of claim 1, wherein the one or more advertisement messages is a text message.

4. The method of claim 1, wherein the one or more advertisement messages is an image.

5. The method of claim 1, wherein the one or more advertisement messages is a combination of an image and a text message.

6. The method of claim 1, wherein the user equipment is a hand-held phone.

7. The method of claim 1, wherein the displaying of the one or more advertisement messages occurs before the displaying of the identification information.

8. The method of claim 1, further comprising the step of determining the location of the at least one user equipment and transmitting one or more location specific advertisement messages.

9. A system for providing an advertisement comprising:
a telephonic network providing telephonic services to a plurality of end user equipment capable of receiving and displaying Caller ID data; and
an advertisement management component that processes one or more advertisement messages such that one or more advertisement messages are sent to at least one of the plurality of end user equipment along with the Caller ID data.
